(19) United States
(12) Patent Application Publication
(10) Pub. No.: US 2023/0275664 A1
(43) Pub. Date: Aug. 31, 2023

(54) OPTICAL COMMUNICATION SYSTEM AND OPTICAL COMMUNICATION METHOD

(71) Applicant: NIPPON TELEGRAPH AND TELEPHONE CORPORATION, Tokyo (JP)

(72) Inventors: Keita NISHIMOTO, Musashino-shi, Tokyo (JP); Kota ASAKA, Musashino-shi, Tokyo (JP); Junichi KANI, Musashino-shi, Tokyo (JP)

(73) Assignee: NIPPON TELEGRAPH AND TELEPHONE CORPORATION, Tokyo (JP)

(21) Appl. No.: 18/017,663

(22) PCT Filed: Jul. 27, 2020
(86) PCT No.: PCT/JP2020/028632

§ 371 Date: Jan. 23, 2023

(51) Int. Cl. H04B 10/2581; H04B 10/50; H04L 12/44

(52) U.S. Cl. CPC H04B 10/2581; H04B 10/501; H04L 12/44

(57) ABSTRACT

An optical communication system allowing for transmission and reception of, between a dynamic bandwidth allocation functional unit that dynamically allocates a bandwidth for uplink communication and a subscriber-side communication device, transmission volume information indicating the amount of information waiting to be transmitted that is stored in the subscriber-side communication device and transmission instruction information for a provider-side communication device to instruct the subscriber-side communication device on a transmission timing for transmitting the transmission volume information, the optical communication system including: a transmission instruction information encoder that acquires multi-level transmission instruction information from the dynamic bandwidth allocation functional unit, converts the multi-level transmission instruction information into binary transmission instruction information, and transmits the encoded binary transmission instruction information to a transmission instruction information decoder; a transmission instruction information decoder that converts the decoded binary transmission instruction information into multi-level transmission instruction information, and outputs the multi-level transmission instruction information to the subscriber-side communication device; a transmission volume information encoder that acquires multi-level transmission volume information from the subscriber-side communication device, converts the multi-level transmission volume information into binary transmission volume information, and transmits the encoded binary transmission volume information to a transmission volume information decoder; and a transmission volume information decoder that converts the decoded binary transmission volume information into multi-level transmission volume information, and outputs the multi-level transmission volume information to the dynamic bandwidth allocation functional unit.

### TECHNICAL FIELD

The present invention relates to an optical communication system and an optical communication method.

### BACKGROUND ART

Recently, an architecture in which a DBA (Dynamic Bandwidth Allocation) function in an OLT (Optical Line Terminal) of a PON (Passive Optical Network) is separated from the hardware of the OLT has been examined (see Non Patent Literature 1 and Non Patent Literature 2, for example). The DBA function is a function of dynamically allocating a communication bandwidth in uplink communication from an ONU (Optical Network Unit) to an OLT according to a traffic amount. FIG. 8 is a diagram illustrating an example of the architecture in which the DBA function in an OLT is separated from the hardware of the OLT. As illustrated in FIG. 8, in the architecture in which the DBA function is separated from the hardware, REPORT information and GATE information (also referred to as “REPORT/GATE information”) need to be transmitted and received between a device in which the DBA function operates and the hardware of the OLT.

Note that the REPORT information refers to information used by an ONU to transfer, to the OLT, the amount of data waiting to be transmitted that is stored in a buffer of the ONU (referred to as “buffer length” hereinafter). The GATE information refers to information used by the OLT to instruct the ONU on a transmission timing and a transmission bandwidth for the information to be transmitted by the ONU. Hereinafter, the REPORT information is also referred to as “transmission volume information,” and the GATE information as “transmission instruction information.” Transmission volume information and transmission instruction information are collectively referred to as “transmission volume transfer information.”

In a case where the architecture described above is adopted, if a plurality of OLTs are installed, a bandwidth available as user data may be squeezed by a plurality of pieces of transmission volume transfer information transmitted and received between the DBA function and the hardware of the OLTs. As a method for solving this problem, there is a conventional method for compressing transmission volume transfer information (see Non Patent Literature 3, for example). The method described in Non Patent Literature 3 can compress the bandwidth of particularly the REPORT information notified from an ONU to an OLT. In this method, the greater the buffer length of the ONU indicated by the REPORT information, the coarser the granularity of the ONU is made, to compress the REPORT information. Thus, since the fixed byte length required for the notification of the REPORT information can be shortened, the bandwidth is compressed.

### CITATION LIST

### Non Patent Literature

[Non Patent Literature 1] M. Ruffini et al., “Virtual DBA: virtualizing passive optical networks to enable multi-service operation in true multi-tenant environments,” Journal of Optical Communications and Networking (JOCN), Vol. 12, No. 4, B63-B73, April 2020.
[Non Patent Literature 2] K. Nishimoto et al., “Mini-PON: disaggregated module-type PON architecture for realizing various PON deployments,” Journal of Optical Communications and Networking (JOCN), Vol. 12, No. 5, pp. 89-98, May 2020.
[Non Patent Literature 3] ITU-T Recommendation G.984.3, “Gigabit-capable Passive Optical Networks (G-PON): Transmission convergence layer specification,” International Telecommunication Union (ITU), February 2004.
[Non Patent Literature 4] Akihiro Otaka, “Future Optical Access Technologies for Flexible Service Deployment,” NTT Technical Journal, pp. 54-58, January 2015
[Non Patent Literature 5] P. Elias, “Universal Codeword Sets and Representations of the Integers,” IEEE Transactions on Information Theory, Vol. IT-21, No. 2, pp. 194-203, March 1975.

### SUMMARY OF INVENTION

### Technical Problem

However, the method described in Non Patent Literature 3 uses non-linear coding, a type of irreversible encoding, to compress information. Non-linear coding, although effective in compressing information, is an irreversible information compression method, so the OLT cannot accurately recognize the buffer length of the ONU from the retrieved REPORT information. Thus, the conventional architecture in which the DBA function is separated from the hardware has a problem that the DBA function of the OLT and the ONU cannot accurately transfer transmission volume transfer information to each other.

In view of the above circumstances, an object of the present invention is to provide an optical communication system and an optical communication method capable of accurately transferring transmission volume transfer information.

### Solution to Problem

One aspect of the present invention is an optical communication system allowing for transmission and reception of, between a dynamic bandwidth allocation functional unit that dynamically allocates a bandwidth for uplink communication from a subscriber-side communication device to a provider-side communication device and the subscriber-side communication device, transmission volume information indicating the amount of information waiting to be transmitted that is stored in the subscriber-side communication device and transmission instruction information for the provider-side communication device to instruct the subscriber-side communication device on a transmission timing for transmitting the transmission volume information, the optical communication system including: a transmission instruction information encoder that acquires multi-level transmission instruction information from the dynamic bandwidth allocation functional unit, converts the multi-level transmission instruction information into binary transmission instruction information, performs encoding on the binary transmission instruction information, and transmits the encoded binary transmission instruction information to a transmission instruction information decoder; a transmission instruction information decoder that receives the encoded binary transmission instruction information transmitted from the transmission instruction information encoder, performs decoding on the encoded binary transmission instruction information, converts the decoded binary transmission instruction information into multi-level transmission instruction information, and outputs the multi-level transmission instruction information to the subscriber-side communication device; a transmission volume information encoder that acquires multi-level transmission volume information from the subscriber-side communication device, converts the multi-level transmission volume information into binary transmission volume information, performs the encoding on the binary transmission volume information, and transmits the encoded binary transmission volume information to a transmission volume information decoder; and a transmission volume information decoder that receives the encoded binary transmission volume information transmitted from the transmission volume information encoder, performs the decoding on the encoded binary transmission volume information, converts the decoded binary transmission volume information into multi-level transmission volume information, and outputs the multi-level transmission volume information to the dynamic bandwidth allocation functional unit.

One aspect of the present invention is an optical communication method allowing for transmission and reception of, between a dynamic bandwidth allocation functional unit that dynamically allocates a bandwidth for uplink communication from a subscriber-side communication device to a provider-side communication device and the subscriber-side communication device, transmission volume information indicating the amount of information waiting to be transmitted that is stored in the subscriber-side communication device and transmission instruction information for the provider-side communication device to instruct the subscriber-side communication device on a transmission timing for transmitting the transmission volume information, the optical communication method including: a transmission instruction information encoding step of acquiring multi-level transmission instruction information from the dynamic bandwidth allocation functional unit, converting the multi-level transmission instruction information into binary transmission instruction information, performing encoding on the binary transmission instruction information, and transmitting the encoded binary transmission instruction information to a transmission instruction information decoder; a transmission instruction information decoding step of receiving the encoded binary transmission instruction information transmitted in the transmission instruction information encoding step, performing decoding on the encoded binary transmission instruction information, converting the decoded binary transmission instruction information into multi-level transmission instruction information, and outputting the multi-level transmission instruction information to the subscriber-side communication device; a transmission volume information encoding step of acquiring multi-level transmission volume information from the subscriber-side communication device, converting the multi-level transmission volume information into binary transmission volume information, performing the encoding on the binary transmission volume information, and transmitting the encoded binary transmission volume information to a transmission volume information decoder; and a transmission volume information decoding step of receiving the encoded binary transmission volume information transmitted in the transmission volume information encoding step, performing the decoding on the encoded binary transmission volume information, converting the decoded binary transmission volume information into multi-level transmission volume information, and outputting the multi-level transmission volume information to the dynamic bandwidth allocation functional unit.

### Advantageous Effects of Invention

According to the present invention, transmission volume transfer information can be transmitted accurately.

### BRIEF DESCRIPTION OF DRAWINGS

FIG. 1 is a block diagram illustrating a configuration of a DBA separation architecture according to a first embodiment of the present invention.

FIG. 2 is a block diagram illustrating an example of implementing the DBA separation architecture according to the first embodiment of the present invention.

FIG. 3 is a diagram illustrating an example of binary information and compressible regions of REPORT information.

FIG. 4 is a diagram illustrating an example of information compression using run-length encoding by the DBA separation architecture according to the first embodiment of the present invention.

FIG. 5 is a flowchart illustrating an example of operations of an optical communication system according to the first embodiment of the present invention.

FIG. 6 is a diagram illustrating an example of information compression based on variable-length numerical representation by the DBA separation architecture according to a second embodiment of the present invention.

FIG. 6 is a diagram illustrating an example of information compression based on variable-length numerical representation by the DBA separation architecture according to a second embodiment of the present invention.

FIG. 8 is a diagram illustrating an example of an architecture in which a DBA function in an OLT is separated from hardware of the OLT.

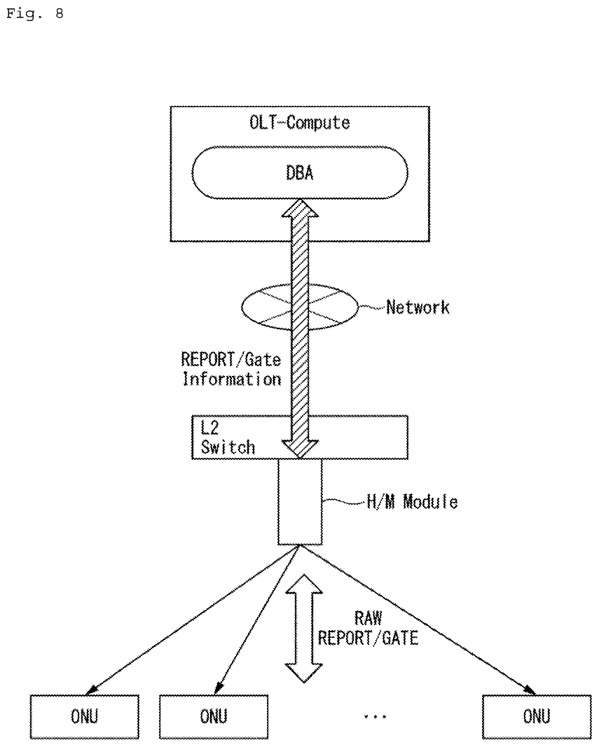

### DESCRIPTION OF EMBODIMENTS

Hereinafter, embodiments of the present invention will be described in detail with reference to the drawings.

In the following explanation, “DBA separation architecture” refers to an architecture in which a DBA function in an OLT of a PON is separated from hardware of the OLT. Note that the DBA function (dynamic allocation function) is a function of dynamically allocating a communication bandwidth for uplink communication from an ONU to the OLT according to the traffic amount. Also, REPORT information (transmission volume information) in the following description refers to information for the ONU to transfer, to the OLT, the amount of data (buffer length) waiting to be transmitted that is stored in a buffer of the ONU. In addition, GATE information (transmission instruction information) refers to information used by the OLT to instruct the ONU on a transmission timing and a transmission bandwidth for information to be transmitted by the ONU.

### First Embodiment

A first embodiment of the present invention will be described hereinafter.

### [Configuration of Optical Communication System]

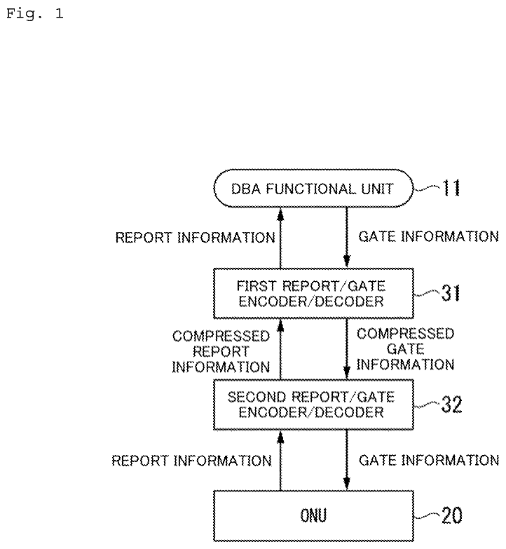

FIG. 1 is a block diagram illustrating a configuration of a DBA separation architecture according to the first embodiment of the present invention. As illustrated in FIG. 1, the DBA separation architecture according to the present embodiment includes a DBA functional unit 11, at least one ONU 20, a first REPORT/GATE encoder/decoder 31, and a second REPORT/GATE encoder/decoder 32. For the purpose of simplifying the drawings, only one ONU 20 is shown in FIG. 1.

The DBA functional unit 11 is a functional unit separated from hardware of the OLT. The DBA functional unit 11 sends GATE information to the ONU 20 via the first REPORT/GATE encoder/decoder 31 and the second REPORT/GATE encoder/decoder 32.

The ONU 20 sends REPORT information to the DBA functional unit 11 via the second REPORT/GATE encoder/decoder 32 and the first REPORT/GATE encoder/decoder 31.

The first REPORT/GATE encoder/decoder 31 and the second REPORT/GATE encoder/decoder 32 are provided between the DBA functional unit 11 and the ONU 20. The first REPORT/GATE encoder/decoder 31 is provided on the DBA functional unit 11 side, and the second REPORT/GATE encoder/decoder 32 is provided on the ONU 20 side. The first REPORT/GATE encoder/decoder 31 and the second REPORT/GATE encoder/decoder 32 perform encoding and decoding on the GATE information and REPORT information transmitted and received therebetween.

The first REPORT/GATE encoder/decoder 31 acquires a raw value of GATE information output from the DBA functional unit 11. The first REPORT/GATE encoder/decoder 31 converts the acquired raw value of the GATE information (multi-level GATE information) into a binary value (binary value). The first REPORT/GATE encoder/decoder 31 encodes the GATE information converted into a binary value by, for example, a compression method described hereinafter. The first REPORT/GATE encoder/decoder 31 sends the GATE information that has been compressed (referred to as “compressed GATE information” hereinafter) to the second REPORT/GATE encoder/decoder 32 on the opposite side.

The second REPORT/GATE encoder/decoder 32 acquires the compressed GATE information sent from the first REPORT/GATE encoder/decoder 31 on the opposite side. The second REPORT/GATE encoder/decoder 32 decodes the acquired compressed GATE information. The second REPORT/GATE encoder/decoder 32 converts the decoded GATE information from the binary value to a multi-value. The second REPORT/GATE encoder/decoder 32 outputs the converted GATE information to the ONU 20.

The second REPORT/GATE encoder/decoder 32 also acquires a raw value of the REPORT information (multi-level REPORT information) output from the ONU 20. The second REPORT/GATE encoder/decoder 32 converts the acquired raw value of the REPORT information into a binary value (binary value). The second REPORT/GATE encoder/decoder 32 encodes the REPORT information converted into a binary value by, for example, a compression method described hereinafter. The second REPORT/GATE encoder/decoder 32 sends the REPORT information that has been compressed (referred to as “compressed REPORT information” hereinafter) to the first REPORT/GATE encoder/decoder 31 on the opposite side.

The first REPORT/GATE encoder/decoder 31 acquires the compressed REPORT information sent from the second REPORT/GATE encoder/decoder 32 on the opposite side. The first REPORT/GATE encoder/decoder 31 decodes the acquired compressed REPORT information. The first REPORT/GATE encoder/decoder 31 converts the decoded REPORT information from the binary value to a multi-value. The second REPORT/GATE encoder/decoder 32 outputs the converted REPORT information to the DBA functional unit 11.

Note that the location where the first REPORT/GATE encoder/decoder 31 is installed varies depending on the architecture. An example of implementing the DBA separation architecture according to the present embodiment will be described hereinafter.

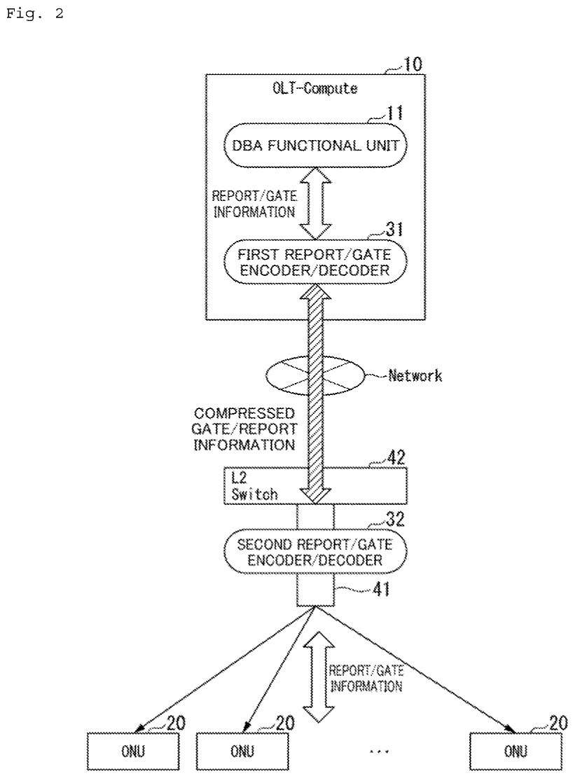

FIG. 2 is a block diagram illustrating an example of implementing the DBA separation architecture according to the first embodiment of the present invention. The DBA separation architecture illustrated in the implementation example of FIG. 2 includes an OLT-Compute 10 (server), a plurality of ONUs 20, a layer 2 switch, an OLT hardware module 41, and a layer 2 switch 42.

As illustrated in FIG. 2, in the present implementation example, the DBA functional unit 11 and the first REPORT/GATE encoder/decoder 31 are implemented in the OLT-Compute 10 (server). In addition, the second REPORT/GATE encoder/decoder 32 is implemented in the OLT hardware module 41. The OLT-Compute 10 (server) and the OLT hardware module 41 are communicably connected via a communication network and the layer 2 switch 42.

Note that the second REPORT/GATE encoder/decoder 32 can be installed on the ONU 20 instead of the OLT hardware module 41. In such a case, although repair costs on the ONU 20 are incurred, an effect of reducing the user-usable bandwidths not only between the DBA functional unit 11 and the OLT hardware module 41 but also in the PON section can be achieved.

[Method for Compressing REPORT/GATE Information] The method for compressing REPORT/GATE information according to the present embodiment will be described hereinafter. In general, a user traffic that is subject to allocation by the DBA functional unit 11 has the characteristic of occurring in bursts. Moreover, the average traffic amount in the PON section of the user traffic that is subject to allocation by the DBA functional unit 11 is characterized in being smaller as compared to of the maximum bandwidth (see, for example, Non Patent Literature 4).

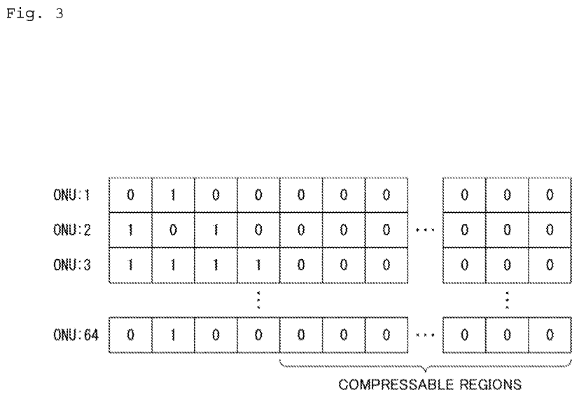

FIG. 3 is a diagram illustrating an example of binary information and compressible regions of the REPORT information. FIG. 3 illustrates a buffered state of the binary information of the REPORT information sent from each ONU 20 or a buffered state of the binary information of the GATE information sent to each ONU 20.

FIG. 3 illustrates the binary information of REPORT/GATE information for 64 ONUS 20 sequentially, with one row having binary information of REPORT information for one ONU 20. The bit length of each row represents the maximum amount prepared in advance for the REPORT/GATE information.

The bit length of the binary information of the REPORT/GATE information transmitted and received between the DBA functional unit 11 and the ONU 20 is often considered to be smaller on average as compared to the maximum amount provided in advance, as shown in FIG. 3. In addition, the binary information of the REPORT/GATE information is considered to often contain many values of “0,”, as shown in FIG. 3. In particular, values of“0” are considered to be often consecutive in the latter half of a bit string of the binary information of each piece of REPORT/GATE information. The region in which values of “0” are consecutive is a region where compression is particularly possible.

The DBA separation architecture according to the present embodiment takes advantage of the characteristics of bit strings. The DBA separation architecture according to the present embodiment performs reversible encoding on the REPORT/GATE information with respect to the above characteristics, which is encoding capable of information compression with a high compression rate. For example, the DBA separation architecture according to the present embodiment performs information compression on the REPORT/GATE information by run-length encoding, as will be described later.

The DBA separation architecture according to the present embodiment allows for efficient information compression of the REPORT/GATE information while accurately transferring the REPORT/GATE information between the DBA functional unit 11 and the ONU 20 by performing reversible encoding.

A method for compressing the REPROT/GATE information by means of run-length encoding will be described hereinafter.

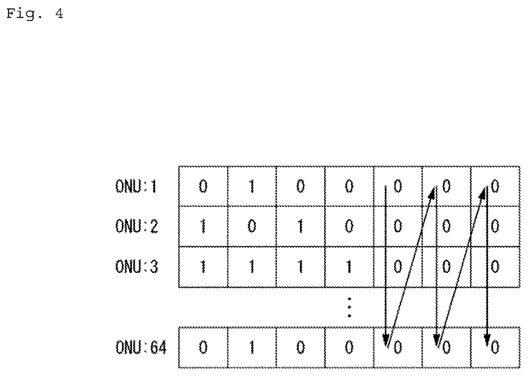

FIG. 4 is a diagram illustrating an example of information compression using run-length encoding by the DBA separation architecture according to the first embodiment of the present invention. As with FIG. 3, FIG. 4 illustrates a buffered state of the binary information of the REPORT information sent from each ONU 20 or a buffered state of the binary information of the GATE information sent to each ONU 20. Also, as with FIG. 3, FIG. 4 illustrates the binary information of the REPORT/GATE information of 64 ONUs 20 sequentially, with one row having binary information of the REPORT information of one ONU 20.

The first REPORT/GATE encoder/decoder 31 arranges the binary information of the GATE information sent to each of the 64 ONUs as shown in FIG. 4. The first REPORT/GATE encoder/decoder 31 performs run-length encoding while scanning the binary information of the arranged GATE information in a longitudinal manner as illustrated in FIG. 4.

Further, the second REPORT/GATE encoder/decoder 32 arranges the binary information of the REPORT information sent by each of the 64 ONUs 20 as shown in FIG. 4. The second REPORT/GATE encoder/decoder 32 performs run-length encoding while scanning the binary information of the arranged REPORT information in a longitudinal manner as illustrated in FIG. 4.

As illustrated in FIG. 3, it is considered that values of “0” are often arranged consecutively in the compressible regions in the REPORT/GATE information. Therefore, by scanning in a longitudinal manner as illustrated in FIG. 4, a bit string in which values of “0” are arranged consecutively longer is encoded by run-length encoding. As a result, the REPORT/GATE information can be compressed at a higher compression rate.

[Operations of Optical Communication System]

Operations of the optical communication system having the DBA separation architecture of the present embodiment will be described hereinafter.

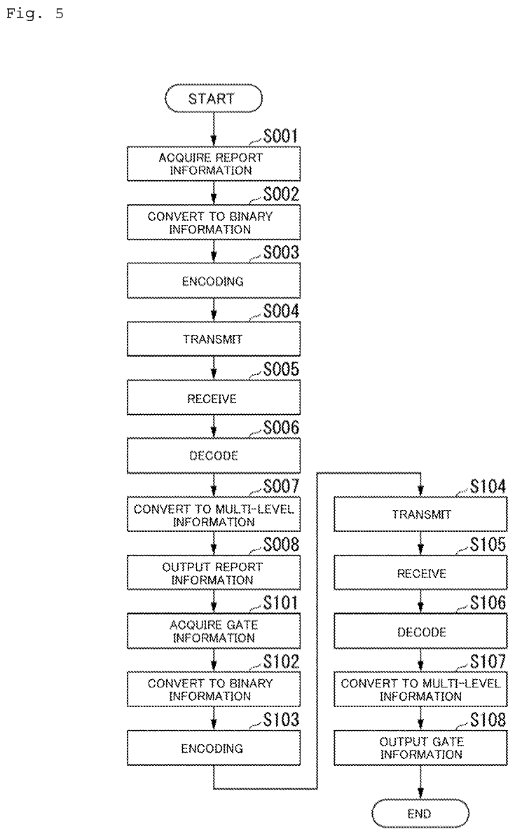

FIG. 5 is a flowchart illustrating an example of operations of the optical communication system according to the first embodiment of the present invention.

The second REPORT/GATE encoder/decoder 32 acquires a raw value of the REPORT information output from each ONU 20 (step S001). The second REPORT/GATE encoder/decoder 32 converts the acquired raw value of the REPORT information into binary information (step S002). The second REPORT/GATE encoder/decoder 32 encodes the binary information of the REPORT information (step S003). In the present embodiment, the second REPORT/GATE encoder/decoder 32 arranges the binary information of the REPORT information of the respective ONUs 20 vertically, scans said binary information in a longitudinal manner, and performs run-length encoding thereon. The second REPORT/GATE encoder/decoder 32 transmits encoded the binary information of the REPORT information to the first REPORT/GATE encoder/decoder 31 (step S004).

The first REPORT/GATE encoder/decoder 31 receives the encoded binary information of the REPORT information transmitted from the second REPORT/GATE encoder/decoder 32 (step S005). The first REPORT/GATE encoder/decoder 31 decodes the encoded binary information of the REPORT information (step S006). The first REPORT/GATE encoder/decoder 31 converts the decoded binary information of the REPORT information into multi-level information (step S007). The first REPORT/GATE encoder/decoder 31 outputs the converted REPORT information to the DBA functional unit 11 (step S008).

The first REPORT/GATE encoder/decoder 31 acquires a raw value of the GATE information output from the DBA functional unit 11 and sent to each ONU 20 (step S101). The first REPORT/GATE encoder/decoder 31 converts the acquired raw value of the GATE information into binary information (step S102). The first REPORT/GATE encoder/decoder 31 encodes the binary information of the GATE information (step S103). In the present embodiment, the first REPORT/GATE encoder/decoder 31 arranges the binary information of the GATE information transmitted to the respective ONUS 20 vertically, scans said binary information in a longitudinal manner, and performs run-length encoding thereon. The first REPORT/GATE encoder/decoder 31 transmits the encoded binary information of the GATE information to the second REPORT/GATE encoder/decoder 32 (step S104).

The second REPORT/GATE encoder/decoder 32 receives the encoded binary information of the GATE information transmitted from the first REPORT/GATE encoder/decoder 31 (step S105). The second REPORT/GATE encoder/decoder 32 decodes the received encoded binary information of the GATE information (step S106). The second REPORT/GATE encoder/decoder 32 converts the decoded binary information of the GATE information into multi-level information (step S107). The second REPORT/GATE encoder/decoder 32 outputs the converted GATE information to each ONU (step S108).

In this manner, the operations of the optical communication system having the DBA separation architecture according to the present embodiment are completed as illustrated in the flowchart of FIG. 5.

As described above, the optical communication system having the DBA separation architecture according to the present embodiment performs reversible encoding on the REPORT information transmitted from the ONU 20 to the DBA functional unit 11 and the GATE information transmitted from the DBA functional unit 11 to the ONU 20. In addition, the optical communication system having the DBA separation architecture according to the present embodiment uses run-length encoding, which is encoding that takes advantage of the characteristics of the REPORT/GATE information transmitted and received between the DBA functional unit 11 and the ONU 20. The characteristics of the REPORT/GATE information here are, as mentioned above, that the bit length of the binary information of the REPORT/GATE information is often smaller on average as compared to the maximum amount prepared in advance, and that the binary information of the REPORT/GATE information often contains many values “0s,” especially in the latter half of the bit string. As a result, the optical communication system having the DBA separation architecture according to the present embodiment allows for efficient information compression of the transmission volume transfer information while accurately transferring the transmission volume transfer information (REPORT/GATE information) between the DBA functional unit 11 and the ONU 20.

### Second Embodiment

The configurations of the DBA separation architecture and the optical communication system equipped with the DBA separation architecture in a second embodiment are the same as those of the first embodiment described above, except for the method for compressing the REPORT/GATE information (encoding method). Therefore, only the method for compressing the REPORT/GATE information according to the second form will be described hereinafter, and the descriptions of other configurations are omitted accordingly.

[Method for Compressing REPORT/GATE Information]

The method for compressing the REPORT/GATE information according to the present embodiment will be described hereinafter. As described above, in general, the user traffic subject to allocation by the DBA functional unit 11 occurs in bursts, and the average traffic amount in the PON section is slightly smaller as compared to that of the maximum bandwidth (see, for example, Non Patent Literature 4). The DBA separation architecture of the first embodiment described above is configured to utilize such characteristics to compress the REPORT/GATE information by run-length encoding.

On the other hand, the DBA separation architecture according to the second embodiment is configured to utilize such characteristics to compress the REPORT/GATE information based on variable-length numerical representation. The following is an example of compressing the REPORT/GATE information, which has been sent from the ONU 20 to the DBA functional unit 11, on the basis of variable-length numerical representation will now be described. Here, the REPORT information is assumed to be information indicating the amount of data (buffer length) waiting to be transmitted that is stored in the buffer of the ONU 20.

The second REPORT/GATE encoder/decoder 32 converts the buffer length of the REPORT information sent from each of the 64 ONUs 20 into a binary value. Next, the second REPORT/GATE encoder/decoder 32 counts the bit lengths of the respective 64 binary values. Next, the second REPORT/GATE encoder/decoder 32 converts each of the 64 bit lengths into a binary value. Hereinafter, the information obtained after the conversion of bit lengths into binary values are referred to as “bit length information.”

Next, the second REPORT/GATE encoder/decoder 32 generates a bit string that combines the bit length information in front of the binary value of the buffer length for each REPORT information sent by each of the 64 ONUs 20. Then, the second REPORT/GATE encoder/decoder 32 transmits the combined bit strings described above to the first REPORT/GATE encoder/decoder 31, starting with the REPORT information at the first ONU 20.

Specific examples will be described hereinafter.

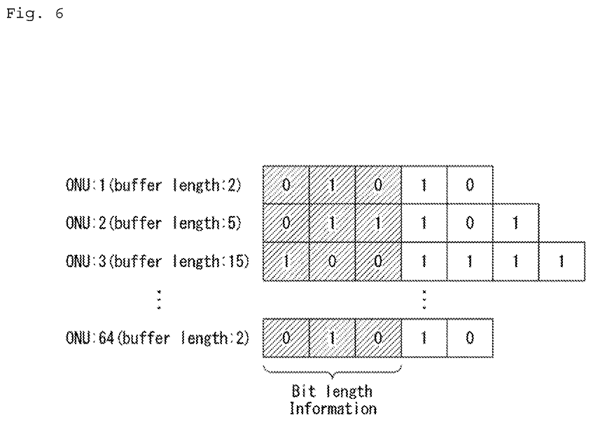

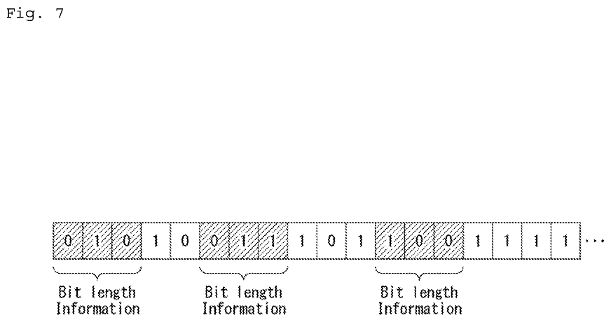

FIGS. 6 and 7 are each a diagram illustrating an example of information compression based on variable-length numerical representation by the DBA separation architecture according to the second embodiment of the present invention. As illustrated in FIG. 6, it is assumed that the buffer length of the first ONU 20 be 2, that the buffer length of the second ONU 20 be 5, that the buffer length of the third ONU 20 be 15, and that the buffer length of the 64th ONU 20 be 2.

The second REPORT/GATE encoder/decoder 32 converts the buffer length of the REPORT information, 2, 5, 15, . . . , 2, sent by the respective 64 ONUs 20, into binary values of “10,” “101,” “1111,”. “10.” Next, the second REPORT/GATE encoder/decoder 32 counts the bit lengths of “10,” “101,” “1111,”. “10.” The bit lengths “10,” “101,” “1111,” . . . “10” are 2, 3, 4, . . . , 2, respectively.

Next, the second REPORT/GATE encoder/decoder 32 converts the bit lengths 2, 3, 4, . . . , 2 into binary values of “10,” “11,” “100,” . . . , and “10,” respectively.

Next, the second REPORT/GATE encoder/decoder 32 combines bit strings “010,” “011,” “100,” . . . , “010” of the bit length information indicating the binary values of the bit lengths in front of the bit strings “10,” “101,” “111,” . . . , “10” indicating the binary values of the buffer lengths, respectively. Accordingly, as illustrated in FIG. 6, the bit string indicating the REPORT information in the first ONU 20 is “01010,” the bit string indicating the REPORT information in the second ONU 20 is “011101,” the bit string indicating the REPORT information in the third ONU 20 is “1001111,” and the bit string indicating the REPORT information in the 64th ONU 20 is “01010.”

It is assumed that bit length N of the bit length information is determined in advance and is shared by plans of the second REPORT/GATE encoder/decoder 32 and the first REPORT/GATE encoder/decoder 31. In the example illustrated in FIG. 6, the bit length N of the bit length information is 3. It is desirable that the value of the bit length N of the bit length information be determined in view of the length which can be taken by the bit length of the bit string indicating the binary value of the buffer length.

Next, as illustrated in FIG. 7, the second REPORT/GATE encoder/decoder 32 transmits, to the first REPORT/GATE encoder/decoder 31, the bit string indicating the REPORT information in each ONU 20, starting with “01010” which is the bit string indicating the REPORT information of the first ONU 20.

Note that the first REPORT/GATE encoder/decoder 31 decodes the REPORT information by performing processing opposite to the processing performed by the second REPORT/GATE encoder/decoder 32 described above.

That is, the first REPORT/GATE encoder/decoder 31 reads the bit length N bits of the bit length information from the top of the acquired bit string, and acquires value M of the bit length information.

Next, the first REPORT/GATE encoder/decoder 31 reads a bit string from N+1 to N+M bits, and acquires information indicating the buffer length of the first ONU 20. The first REPORT/GATE encoder/decoder 31 then executes the foregoing processing again with the N+M+1 bit as the top, in order to acquire information indicating the buffer length of the first ONU 20. The first REPORT/GATE encoder/decoder 31 sequentially repeats the foregoing processing to acquire information indicating buffer lengths of all ONUS 20.

As described above, the optical communication system having the DBA separation architecture according to the present embodiment performs reversible encoding on the REPORT information transmitted from the ONU 20 to the DBA functional unit 11 and the GATE information transmitted from the DBA functional unit 11 to the ONU 20. The optical communication system having the DBA separation architecture according to the present embodiment uses a compression method based on variable-length numerical representation which is encoding utilizing the characteristics of the REPORT/GATE information transmitted and received between the DBA functional unit 11 and the ONU 20. The characteristics of the REPORT/GATE information here are, as mentioned above, that the bit length of the binary information of the REPORT/GATE information is often smaller on average as compared to the maximum amount prepared in advance, and that the binary information of the REPORT/GATE information often contains many values “0s,” especially in the latter half of the bit string.

As described above, in the optical communication system having the DBA separation architecture in the present embodiment, a bit string indicating bit length information is added in front of the bit string of the binary value indicating the buffer length of each ONU20. Thereafter, the optical communication system arranges (combines) bit strings corresponding to the respective ONUS 20 sequentially without any gap, and transmits these bit strings. As a result, the optical communication system can omit processing for filling bit strings with values of “0” for no reason, and can therefore efficiently compress the REPORT/GATE information.

Thus, the optical communication system having the DBA separation architecture according to the present embodiment can perform efficient information compression on the transmission volume transfer information while accurately transferring the transmission volume transfer information between the DBA functional unit 11 and the ONU 20.

The optical communication system of the present embodiment is configured to use variable-length numerical representation as a method of information compression, but may alternatively use integer encoding. Integer encoding is an encoding method for allocating a short bit string to a small value, as with variable-length numerical representation. Examples of integer encoding include Elias gamma encoding described in Non Patent Literature 5 and delta encoding. When integer coding is used, the effect is expected to be the same as when the above-described variable-length numerical representation is used. That is, even when integer encoding is used, the optical communication system having the DBA separation architecture can perform efficient information compression on the transmission volume transfer information while accurately transferring the transmission volume transfer information between the DBA functional unit 11 and the ONU 20.

According to each of the embodiments described above, the optical communication system transmits and receives transmission volume information and transmission instruction information between a dynamic bandwidth allocation functional unit and a subscriber-side communication device. The dynamic bandwidth allocation functional unit dynamically allocates a bandwidth for uplink communication from the subscriber-side communication device to the provider-side communication device. The transmission volume information indicates the amount of information waiting to be transmitted that is stored in the subscriber-side communication device. The transmission instruction information is information for the provider-side communication device to instruct the subscriber-side communication device on a transmission timing for transmitting the transmission volume information. For example, the dynamic bandwidth allocation functional unit is the DBA functional unit 11 in the embodiments, the subscriber-side communication device is the ONU 20 in the embodiments, the transmission volume information is REPORT information in the embodiments, the transmission instruction information is GATE information in the embodiments, and the amount of information waiting to be transmitted that is stored in the subscriber-side communication device is the buffer length in the embodiments.

The optical communication system includes a transmission instruction information encoder, a transmission instruction information decoder, a transmission volume information encoder, and a transmission volume information decoder. For example, the transmission instruction information encoder is the first REPORT/GATE encoder/decoder 31 in the embodiments, the transmission instruction information decoder is the second REPORT/GATE encoder/decoder 32 in the embodiments, the transmission volume information encoder is the second REPORT/GATE encoder/decoder 32 in the embodiments, and the transmission volume information decoder is the first REPORT/GATE encoder/decoder 31 in the embodiments.

The transmission instruction information encoder acquires multi-level transmission instruction information from the dynamic bandwidth allocation functional unit, converts the multi-level transmission instruction information into binary transmission instruction information, performs encoding on the binary transmission instruction information, and transmits the encoded binary transmission instruction information to the transmission instruction information decoder. For example, the multi-level transmission instruction information is a raw value of the GATE information in the embodiments, the binary transmission instruction information is a binary value of the GATE information in the embodiments, and encoding is, for example, a compression method based on run-length encoding, variable-length numerical representation, or integer encoding in the embodiments.

The transmission instruction information decoder receives the encoded binary transmission instruction information transmitted from the transmission instruction information encoder, performs decoding on the encoded binary transmission instruction information, converts the decoded binary transmission instruction information into multi-level transmission instruction information, and outputs the multi-level transmission instruction information to the subscriber-side communication device.

The transmission volume information encoder acquires multi-level transmission volume information from the subscriber-side communication device, converts the multi-level transmission volume information into binary transmission volume information, performs encoding on the binary transmission volume information, and transmits the encoded binary transmission volume information to the transmission volume information decoder. For example, the multi-level transmission volume information is a raw value of the REPORT information in the embodiments, the binary transmission volume information is a binary value of REPORT information in the embodiments, and encoding is, for example, a compression method based on run-length encoding, variable-length numerical representation, or integer encoding in the embodiments.

The transmission volume information decoder receives the encoded binary transmission volume information transmitted from the transmission volume information encoder, performs decoding on the encoded binary transmission volume information, converts the decoded binary transmission volume information into multi-level transmission volume information, and outputs the multi-level transmission volume information to the dynamic bandwidth allocation functional unit.

The transmission instruction information encoder and the transmission volume information encoder perform encoding by a reversible compression method. For example, the reversible compression method is an encoding method based on a run-length encoding method, variable-length numerical representation, or integer encoding based encoding in the embodiments.

Part of the configurations of the DBA separation architecture and the optical communication system equipped with the DBA separation architecture according to each of the embodiments described above may be realized by a computer. In such a case, the functions may be realized by recording a program for implementing the functions in a computer-readable recording medium, loading the program recorded on this recording medium to a computer system, and executing the program. It is assumed that the “computer system” as used herein includes an OS and hardware such as peripheral devices. In addition, the “computer-readable recording medium” refers to a portable medium such as a flexible disk, a magneto-optical disk, a ROM, or a CD-ROM, or a storage apparatus such as a hard disk that is built into the computer system. Furthermore, the “computer-readable recording medium” may also include a recording medium that dynamically holds a program for a short period of time such as a communication wire when the program is to be transmitted via a network such as the Internet or a communication line such as a telephone line, as well as a recording medium that holds a program for a certain period of time such as a volatile memory inside a server or a computer system serving as a client. Moreover, the program described above may be any of a program for realizing some of the functions described above, a program capable of realizing the functions described above in combination with a program already recorded in a computer system, and a program for realizing the functions using a programmable logic device such as an FPGA (Field Programmable Gate Array).

Although the embodiments of the present invention have been described in detail with reference to the drawings, specific configurations are not limited to these embodiments, and designs and the like within a range that does not deviate from the gist of the present invention are also included.

### REFERENCE SIGNS LIST

10 . . . OLT-Compute, 11 . . . DBA functional unit, 31 . . . First REPORT/GATE encoder/decoder, 32 . . . Second REPORT/GATE encoder/decoder, 41 . . . OLT hardware module

1. An optical communication system allowing for transmission and reception of, between a dynamic bandwidth allocation functional unit that dynamically allocates a bandwidth for uplink communication from a subscriber-side communication device to a provider-side communication device and the subscriber-side communication device, transmission volume information indicating the amount of information waiting to be transmitted that is stored in the subscriber-side communication device and transmission instruction information for the provider-side communication device to instruct the subscriber-side communication device on a transmission timing for transmitting the transmission volume information, the optical communication system comprising:
a transmission instruction information encoder that acquires multi-level transmission instruction information from the dynamic bandwidth allocation functional unit, converts the multi-level transmission instruction information into binary transmission instruction information, performs encoding on the binary transmission instruction information, and transmits the encoded binary transmission instruction information to a transmission instruction information decoder;
a transmission instruction information decoder that receives the encoded binary transmission instruction information transmitted from the transmission instruction information encoder, performs decoding on the encoded binary transmission instruction information, converts the decoded binary transmission instruction information into multi-level transmission instruction information, and outputs the multi-level transmission instruction information to the subscriber-side communication device;
a transmission volume information encoder that acquires multi-level transmission volume information from the subscriber-side communication device, converts the multi-level transmission volume information into binary transmission volume information, performs the encoding on the binary transmission volume information, and transmits the encoded binary transmission volume information to a transmission volume information decoder; and
a transmission volume information decoder that receives the encoded binary transmission volume information transmitted from the transmission volume information encoder, performs the decoding on the encoded binary transmission volume information, converts the decoded binary transmission volume information into multi-level transmission volume information, and outputs the multi-level transmission volume information to the dynamic bandwidth allocation functional unit.

2. The optical communication system according to claim 1, wherein the transmission instruction information encoder and the transmission volume information encoder perform the encoding by a reversible compression method.

3. The optical communication system according to claim 2, wherein the transmission instruction information encoder and the transmission volume information encoder perform the encoding by a run-length encoding method.

4. The optical communication system according to claim 2, wherein the transmission instruction information encoder and the transmission volume information encoder perform the encoding by an encoding method based on variable-length numerical expression.

5. The optical communication system according to claim 2, wherein the transmission instruction information encoder and the transmission volume information encoder perform the first-term encoding by an encoding method based on integer encoding.

6. An optical communication method allowing for transmission and reception of transmission volume information and transmission instruction information between a dynamic bandwidth allocation functional unit and a subscriber-side communication device, the optical communication method comprising:
a transmission instruction information encoding step of acquiring multi-level transmission instruction information from the dynamic bandwidth allocation functional unit, converting the multi-level transmission instruction information into binary transmission instruction information, performing encoding on the binary transmission instruction information, and transmitting the encoded binary transmission instruction information to a transmission instruction information decoder;
a transmission instruction information decoding step of receiving the encoded binary transmission instruction information transmitted in the transmission instruction information encoding step, performing decoding on the encoded binary transmission instruction information, converting the decoded binary transmission instruction information into multi-level transmission instruction information, and outputting the multi-level transmission instruction information to the subscriber-side communication device;
a transmission volume information encoding step of acquiring multi-level transmission volume information from the subscriber-side communication device, converting the multi-level transmission volume information into binary transmission volume information, performing the encoding on the binary transmission volume information, and transmitting the encoded binary transmission volume information to a transmission volume information decoder; and
a transmission volume information decoding step of receiving the encoded binary transmission volume information transmitted in the transmission volume information encoding step, performing the decoding on the encoded binary transmission volume information, converting the decoded binary transmission volume information into multi-level transmission volume information, and outputting the multi-level transmission volume information to the dynamic bandwidth allocation functional unit.
